(19) United States
(12) Patent Application Publication
(10) Pub. No.: US 2026/0192936 A1
(43) Pub. Date: Jul. 9, 2026

(54) Bird Deflection System

(71) Applicant: Tomas Leszczynski, Ringwood, NJ (US)

(72) Inventor: Tomas Leszczynski, Ringwood, NJ (US)

(73) Assignee: Aviiox Tomasz Leszczynski, Wroclaw (PL)

(21) Appl. No.: 19/383,922

(22) Filed: Nov. 10, 2025

Related U.S. Application Data
(60) Provisional application No. 63/827,211, filed on Jun. 20, 2025.

(51) Int. Cl. B64D 33/02

(52) U.S. Cl. CPC B64D 33/02; B64D 2033/022

(57) ABSTRACT

A Bird Deflection System (BDS) for aircraft employs sequential layers of high-velocity air to divert birds from the engine intake region. The system includes nozzle arrays positioned forward of the engines, a compressed-air or electric airflow source, and a controller responsive to radar, lidar, or optical bird-detection data. Multiple air curtains, oriented at various angles, act to rotate and laterally deflect birds before impact. Compressed-gas, preferably dry nitrogen, or supercapacitor-driven electric embodiments provide millisecond-scale activation similar to automotive airbag systems. The system minimally affects flight dynamics and may be validated using a ground-testing rig replicating aircraft geometry and airflow. The invention enhances aviation safety by preventing bird ingestion through active aerodynamic deflection and is designed to be refilled using standard airport equipment.

### PRIORITY

U.S. Provisional Ser. No. 63/827,211, filed Jun. 20, 2025.

### CROSS-REFERENCE TO RELATED APPLICATION

This application claims the benefit of U.S. Provisional Patent Application No. 63/827,211, filed Jun. 20, 2025, entitled “Bird Deflection System,” the entire disclosure of which is incorporated herein by reference.

### FIELD OF THE INVENTION

The invention relates to aircraft safety systems and more particularly to an active system to deflect birds away from aircraft engines before impact.

### BACKGROUND OF THE INVENTION

Bird strikes present a significant hazard to general aviation, particularly during takeoff and landing when aircraft operate below 10,000 feet. While modern engines are designed to withstand limited bird ingestion, they may fail upon impact with large birds or multiple simultaneous strikes.

Conventional bird-strike prevention methods, such as radar monitoring, pyrotechnic deterrents, and acoustic systems, provide only partial protection and are ineffective once birds approach the immediate vicinity of the aircraft. Existing mechanical ideas including net protection of the intake of the engine are not yet practical. The high frequency of bird collisions underscores the need for an on-board, rapidly responding system that can physically divert birds from the aerodynamic flow path leading into the engines without adversely affecting flight performance.

The Bird Deflection System (“BDS”) invention introduces a principle similar to automotive airbag systems: a rapidly expanding, short-duration Air Curtains that deploy only in emergency conditions to form a transient, cushion-like barrier of high-velocity air. This barrier deflects birds away from the engines, then immediately dissipates without leaving residue or mechanical obstruction. The system can be replenished on the ground after activation using standard airport equipment, or automatically recharged in flight when electric fans are employed.

The invention includes sensing modules, such as radar, lidar, optical, or infrared systems, that detect approaching birds and initiate activation of BDS. In some embodiments, these sensing modules further calculate the flight path of detected birds to enable selective activation of specific nozzles for enhanced precision.

### SUMMARY OF THE INVENTION

The invention provides a BDS mounted forward of the engines. The system integrates within existing aircraft structures, typically adjacent to the front wheel assembly housing, where available space between the wheel box and the airframe accommodates BDS units on both sides of the aircraft.

The BDS generates one or more layers of high-velocity air, referred to as “Air Curtains,” to deflect approaching birds within the Bird Cone, a dynamically computed conical hazard region representing potential bird-collision trajectories ahead of each engine intake.

Because of the difference in speed vectors between the aircraft and the birds, only those within the Bird Cone present a risk to the engines. Birds outside this region are disregarded. Small, high-speed raptors such as falcons may occasionally enter from outside the Bird Cone, but their solitary behavior and low mass make them non-critical.

The system detects birds within a defined “Detection Cone” ahead of the aircraft using radar, lidar, optical, or infrared sensors. Upon detection, the control unit activates either compressed-gas or electrically driven airflow sources to discharge sequential Air Curtains across the Bird Cone. In certain embodiments, the BDS controls individual nozzles based on the computed flight path of an approaching bird and may adjust nozzle orientation or movement during discharge. In advanced configurations, a single high-response nozzle may rotate to track the bird in real time, maintaining continuous targeted airflow for maximum deflection efficiency.

Each curtain is oriented at a predetermined angle relative to the flight direction so that the first curtain induces rotation of an incoming bird into a high-drag “parachute” orientation. Subsequent curtains apply increasing lateral aerodynamic forces that displace the bird away from the engine intake.

Computational flow analysis indicates the formation of a Phantom Wing region in front of the engines, characterized by a high-velocity core that drives birds laterally outward. The Phantom Wing geometry aligns with the engine centerline, maintaining laminar airflow and ensuring no adverse impact on engine performance.

The system may employ either (a) compressed dry nitrogen gas equipped with fast-acting valves and plenum chambers, or (b) electric-motor-driven blowers powered by supercapacitors for repeated activation. In configuration (a), the gas system is refilled using standard 207-bar nitrogen service bottles commonly available at airports for aircraft pneumatic servicing.

The BDS may also incorporate a ground-test configuration for flow simulation or wind-tunnel verification of nozzle geometry, curtain formation, and overall aerodynamic performance.

### BRIEF DESCRIPTION OF THE DRAWINGS

FIG. 1 illustrates a top view of an aircraft equipped with a Bird Deflection System (BDS) positioned to protect the left-side engine, showing representative air-curtain arrangement and deflection of an approaching bird.

FIG. 2 schematically illustrates the concept of a Bird Cone defining the potential hazard zone ahead of each engine intake, derived from relative aircraft and bird velocities.

FIG. 3 illustrates the BDS and Bird Cone relationship, showing air curtains forming a deflection envelope that laterally displaces approaching birds away from the engine.

FIG. 4 illustrates the relationship between the Bird Cone and a Detection Cone defining the sensor field used to detect birds and trigger system activation.

FIG. 5 illustrates a nozzle manifold embodiment comprising five air curtains, each with multiple vertical nozzles fluidly connected to one or more nitrogen bottles.

FIG. 6 illustrates a nozzle manifold mounted beneath a section of aircraft skin with flap-type covers over the nozzle exits that open during operation and close automatically afterward.

FIG. 7 illustrates a single BDS panel spanning two fuselage-frame sections, showing rows and columns of nozzles with protective flap covers.

FIG. 8 illustrates the path of a bird traversing sequential air curtains and the formation of a high-speed “Phantom Wing” region that deflects the bird laterally away from the engine.

FIG. 9 shows selected computational-fluid-dynamics flow tracers depicting velocity zones produced by the BDS and the resulting high-velocity deflection envelope outside the engine intake.

FIG. 10 illustrates a vertical CFD cross-section through the engine intake showing the “Phantom Wing” flow pattern and smooth re-entry of the deflected airflow into the main airstream.

### DESCRIPTION OF THE PREFERRED EMBODIMENT

### General Arrangement

The BDS is positioned on the aircraft fuselage forward of the engine inlets, typically near the front wheel assembly box. The system defines a Bird Cone representing the volume through which birds may enter an engine intake during flight speed below 250 mph, the typical speed of bird strikes below 10,000 feet.

A corresponding Detection Cone extends forward approximately 100 m ahead of the aircraft and triggers system activation when birds are detected within that region. A more advanced system may calculate the path of the birds and limit discharge and timing to select valves.

### Air Curtains

The BDS forms multiple Air Curtains directed transversely to the aircraft longitudinal axis. Each curtain is produced by an array of nozzles connected to a pressurized-air manifold. Typical nozzle exit velocity is about 300 m/s, with a discharge duration of less than one second. The curtains are oriented progressively, for example, at approximately 60°, 70°, 75°, 80°, and 85°relative to the flight direction. This configuration allows each curtain to benefit from the aerodynamic shielding effect of the preceding one, enabling maximum horizontal displacement force on the incoming birds.

The first curtain functions as a tripping layer, inducing rotation of the bird's body to increase aerodynamic drag, similar to an umbrella or parachute aligning with the direction of the wind. In the preferred embodiment, the tripping curtain is spaced forward from the subsequent curtains to allow sufficient time for the bird to rotate, thereby greatly enhancing the deflection force produced by the following Air Curtains acting on the bird in its high-drag orientation.

### Compressed-Gas Embodiment

In one embodiment, each Air Curtain is supplied by high-pressure bottles containing dry nitrogen gas at approximately 207 bar. The bottles are connected through a plenum chamber and fast-acting pneumatic valves that regulate gas release. When triggered, the stored gas expands through the Air Curtain nozzles either as a single, simultaneous discharge or in curtain-specific timing sequences. If activated during flight, the system can be refilled on the ground using standard compressed dry-nitrogen service bottles commonly available at airports. The use of dry nitrogen prevents icing, eliminates moisture accumulation, and minimizes any risk of engine disturbance because nitrogen's physical properties closely match those of air.

### Electric-Motor Embodiment

An alternative embodiment employs electric ducted fans (“EDF”) or centrifugal blowers driven by high-power electric motors. These units accelerate ambient air through nozzles positioned to form the Air Curtains without the need for stored gas or pressurized bottles. Supercapacitors supply instantaneous high-current discharge, allowing the motors to accelerate rapidly producing the required airflow for effective bird deflection.

The supercapacitors are maintained at full charge by a controlled DC-DC converter connected to the aircraft's electrical bus, typically operating at 28 V DC or 115 V AC converted to DC. Charging current is limited to protect the aircraft power system, allowing gradual recharging during normal flight. In certain configurations, a battery maintains standby voltage and automatically restores capacitor charge after each deployment.

Because airflow is generated directly rather than stored, this embodiment enables multiple activations during flight without external refilling or maintenance between flights. However, current electric motor and capacitor technology results in greater overall system mass compared to the compressed-gas embodiment, and may require additional cooling or thermal management provisions to dissipate heat generated during rapid cycling.

### Detection and Triggering

Detection may rely on radar, lidar, or optical sensors directed along the flight path. A control unit determines bird presence, range, and vector. Activation logic may fire all curtains simultaneously or selectively depending on computed trajectory. The control unit interfaces with standard aircraft avionics but may also operate independently as a sealed subsystem.

### Aerodynamic Effects and Safety

Computational flow analysis indicates negligible influence on aircraft stability. In a typical large-aircraft configuration with one-sided activation, calculated yaw is below 0.2 degrees and worst transient speed reduction is less than 3 mph, comparable to any wind conditions. Because the air curtains dissipate long before reaching the engines, no sustained aerodynamic asymmetry remains.

### Ground-testing and Simulation

A separate embodiment provides a test rig comprising a structural frame replicating the nose section of an aircraft, equipped with identical nozzle arrays and detection sensors. The rig is installed in a wind-tunnel or open-jet facility and connected to compressed-air or electric-blower sources to evaluate nozzle geometry, flow uniformity, and response time. The testing apparatus forms part of the inventive concept because it validates the aerodynamic deflection mechanism using the same control algorithms.

### Materials and Integration

Components may be manufactured from aluminium alloys, carbon composites, or titanium. The nozzle manifold due to it's complexitity may be 3D metal printed. Pneumatic lines and aviation nitrogen bottles use standard aviation fittings. Mounting structures are designed for easy integration with existing aircraft fuselage frames without altering load paths.

### Operation

During take-off roll, the system arms automatically when airspeed and height above ground exceeds a preset threshold. Upon bird detection, selected curtains, or all of them at the same time, discharge high-velocity gas, forming a transient aerodynamic barrier. After discharge, the gas based system needs to be refueled at the next airport, and electric based system slowly recharges during flight and/or using ground operations.

### DETAILED ILLUSTRATION OF DRAWINGS

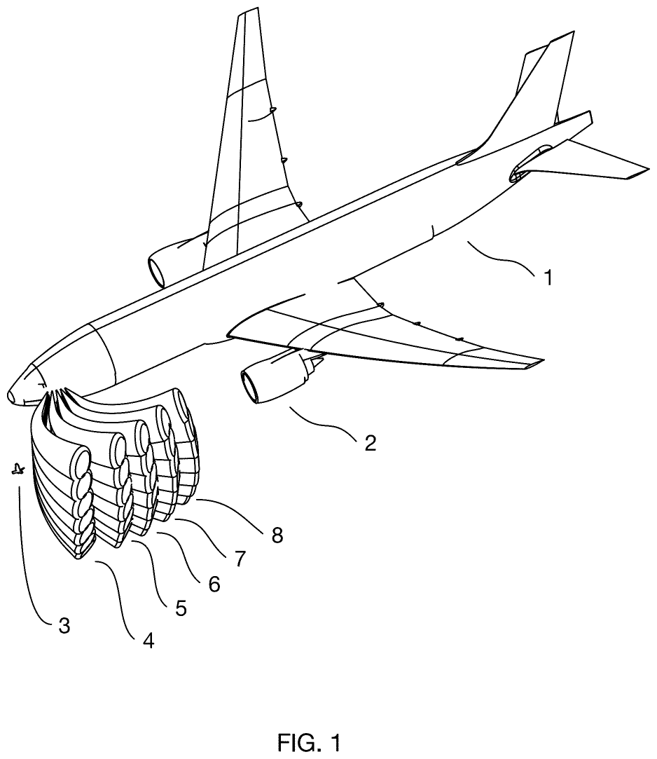

FIG. 1 illustrates a top view of aircraft 1 having a Bird Deflection System (BDS) mounted on the left side of the aircraft to protect left-side engine 2. A representative large bird 3 is shown approaching and entering a set of air curtains arranged in a five-curtain configuration, including a first tripping curtain 4 followed by successive curtains 5, 6, 7, and 8. During operation, the system induces rotation of the bird into a high-drag orientation and produces lateral aerodynamic forces that displace the bird away from engine 2. An identical, symmetrical BDS arrangement is positioned on the right side of the aircraft to protect the opposite engine.

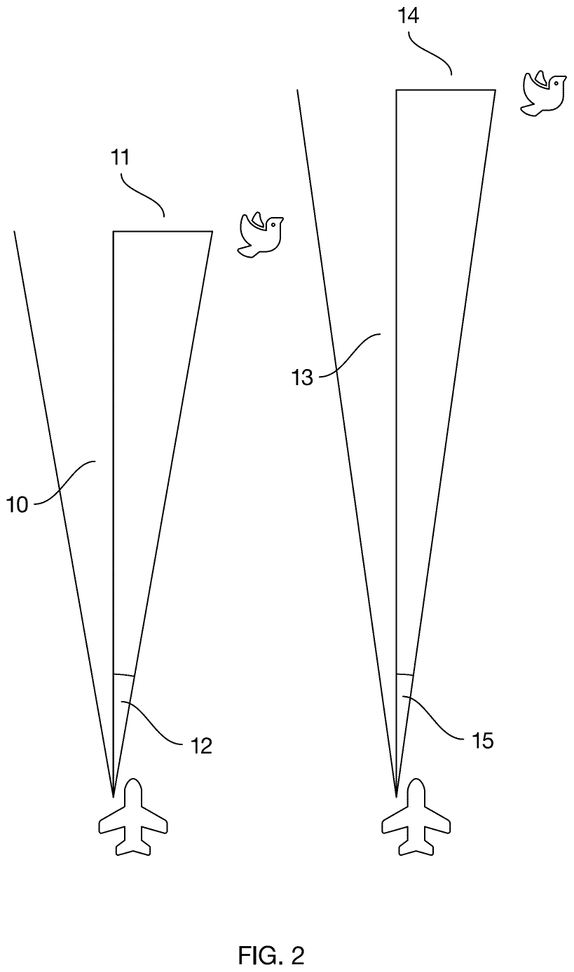

FIG. 2 schematically illustrates the concept of a Bird Cone defining the potential hazard zone forward of each engine intake. Aircraft speed vector 10 and bird speed vector 11 define a relative-velocity geometry that produces a conical region having cone half-angle 12. The system is configured to disregard high-speed raptors, such as falcons, which may approach from outside the Bird Cone because their solitary behavior and relatively small mass present minimal risk to the engine. The Bird Cone is computed dynamically from the current aircraft speed, altitude, and operating conditions typical of take-off, landing, and flight below 10 000 ft, representing the most probable bird-strike scenarios. The cone half-angle 12 is based on a worst-case assumption of a large bird flying approximately 90 degrees to the aircraft's flight path and intersecting the engine-intake region, typically yielding a half-angle in the range of eight to eleven degrees. As aircraft speed increases (aircraft speed vector 13) while bird speed remains approximately constant (bird speed vector 14), the corresponding Bird Cone half-angle 15 decreases proportionally.

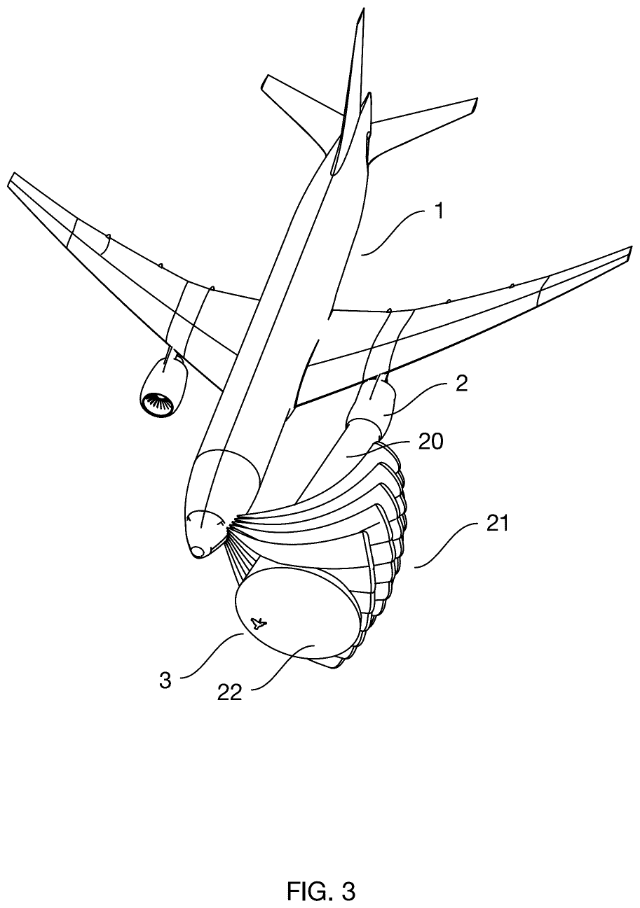

FIG. 3 illustrates aircraft 1 with left-side engine 2 protected by the BDS and the associated Bird Cone 20. A representative large bird 3 is shown approaching and entering the Bird Cone in front of entry zone 22. The system includes a series of air curtains 21 configured to form a deflection envelope that fully encompasses the Bird Cone 20 and laterally displaces approaching objects away from engine 2.

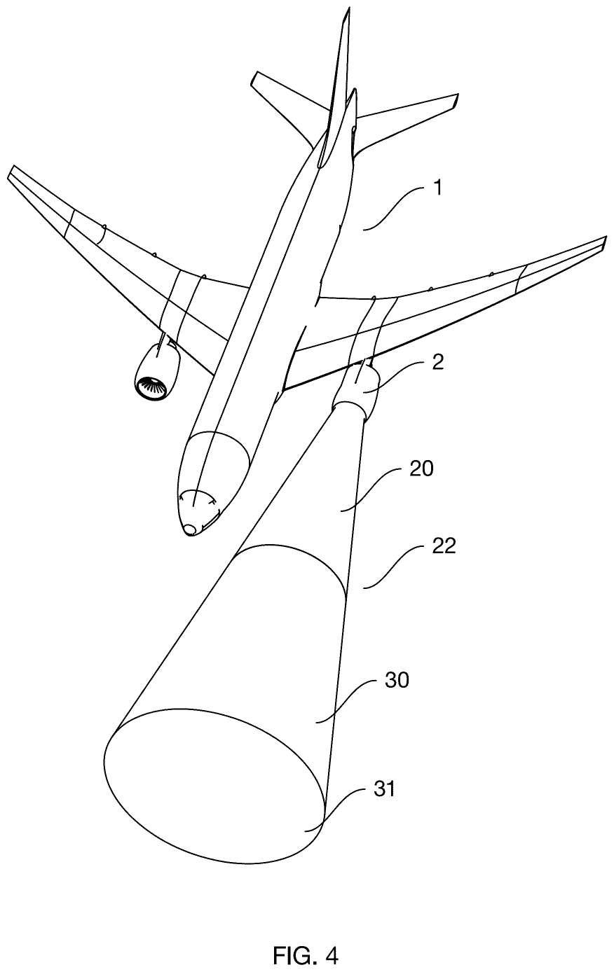

FIG. 4 illustrates aircraft 1 with left-side engine 2 protected by the BDS, showing the relationship between the Bird Cone 20 and the Detection Cone 30. The Detection Cone 30 defines the forward sensing region used to identify approaching birds and initiate system activation. Entry point 31 represents the boundary of the Detection Cone, while entry zone 22 denotes the corresponding entry to the Bird Cone. The Detection Cone 30 establishes the space within which the presence of birds triggers operation of the BDS.

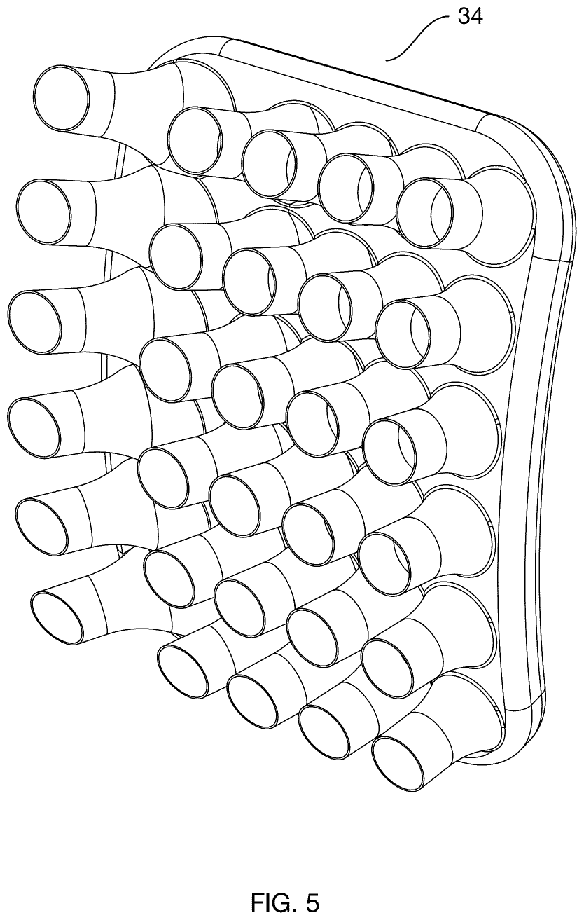

FIG. 5 illustrates a nozzle manifold represented in this embodiment as five air curtains, each including six vertical nozzles. The configuration is not limited to a uniform grid pattern and may be adapted to optimize the “Phantom Wing” airflow effect, thereby generating maximum core wind speed across the deflection envelope. The nozzle manifold is fluidly connected at its rear section to one or more nitrogen bottles (not shown), serving as the source of pressurized gas for system operation.

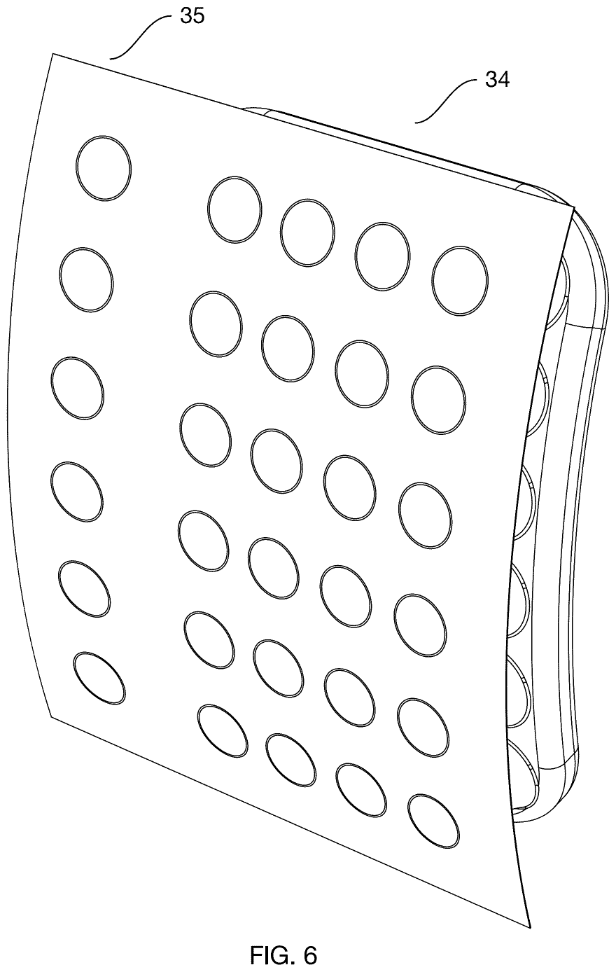

FIG. 6 illustrates nozzle manifold 34 mounted beneath a section of aircraft skin 35 with multiple visible nozzle exits. Each nozzle exit is covered by a flap-type cover configured to open outward into the airstream during system activation and to close automatically under air pressure after gas discharge.

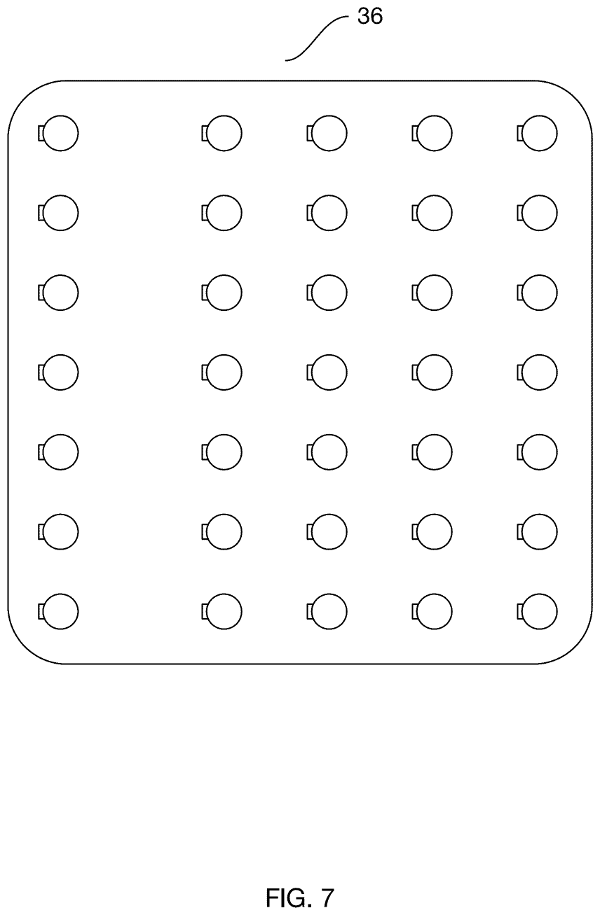

FIG. 7 illustrates a view of the BDS installed as a single panel 36 spanning two structural sections of the aircraft, assumed as 500 mm between fuselage frame spacing. The panel 36 includes multiple rows and columns of nozzles, each equipped with protective flap covers configured to open during gas discharge and close under ambient air pressure following activation.

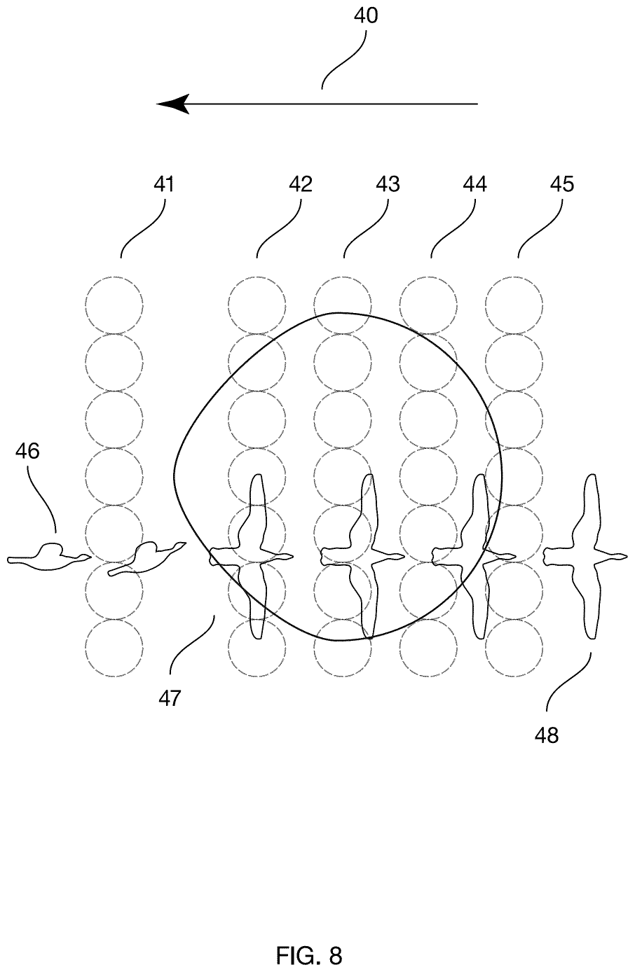

FIG. 8 illustrates the path of a bird crossing sequential air curtains 41, 42, 43, 44, and 45. The forward air curtain 41 expels compressed gas laterally at high velocity, striking bird 46 and inducing rotation into a high-drag or “parachute” orientation. The spacing between air curtain 41 and the remaining air curtains 42-45 is selected to permit completion of this rotation before the subsequent curtains apply maximum lateral aerodynamic forces. Area 47 represents the region identified through computational fluid-dynamics analysis as the core high-speed zone of the generated “Phantom Wing” during system operation. The bird exits the curtain sequence at 48 with lateral acceleration sufficient to move it outside the engine-intake region. Birds deflected by BDS are expected to regain stable flight shortly after displacement.

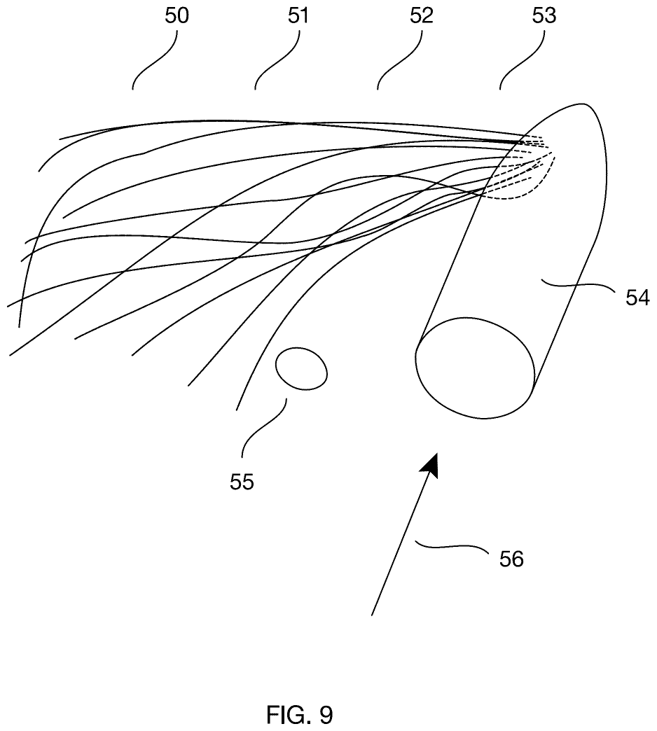

FIG. 9 shows selected flow tracers from a computational fluid-dynamics analysis of the BDS. The front of the aircraft 54 travels at a speed of approximately 100 m/s in direction 56 toward left-side engine intake 55. The analysis identifies representative velocity regions, including section 53 with flow velocities of 250-300 m/s, section 52 with 200-250 m/s, section 51 with 150-200 m/s, and section 50 with 100-150 m/s, where the discharged gas merges with the surrounding airstream. The results indicate that the BDS discharge forms a high-velocity deflection envelope outside the left-side engine intake 55, producing sufficient lateral aerodynamic force to displace approaching birds away from the engine-intake region.

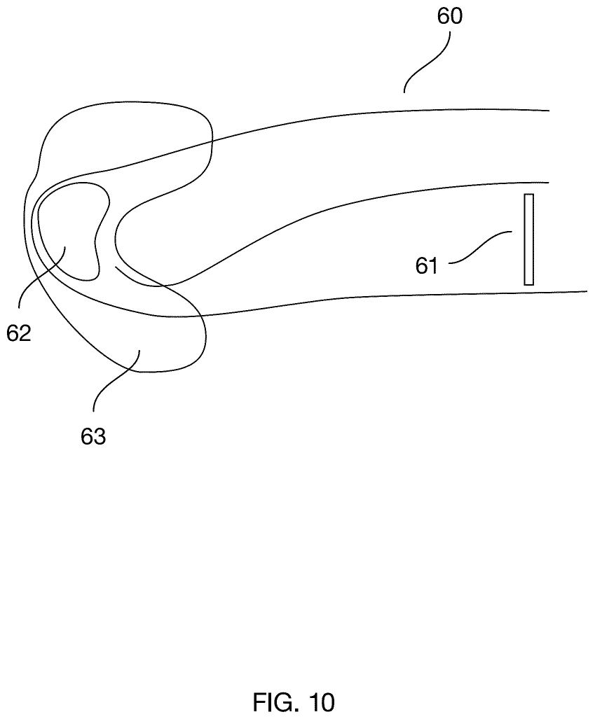

FIG. 10 illustrates a computational fluid-dynamics cross section aligned vertically through the center of the left engine intake 61. The analysis shows formation of a Phantom Wing region characterized by a high lateral-speed core 62 of approximately 200 m/s. Surrounding the core is an envelope 63 with velocities of approximately 150 m/s. The Phantom Wing flow merges smoothly with the main airstream at region 60, demonstrating minimal aerodynamic disturbance to the aircraft engines.

1. A bird deflection system (BDS) for an aircraft, comprising:
(a) a plurality of nozzles configured to generate at least one air curtain across a flight-path region forward of an engine intake;
(b) a source of pressurized gas or airflow fluidly coupled to the nozzles; and
(c) a controller configured to activate the source in response to detection of one or more birds within a predetermined detection zone.

2. The system of claim 1, wherein each air curtain is oriented at a selected angle relative to the longitudinal axis of the aircraft.

3. The system of claim 1, wherein the nozzles are arranged in multiple rows forming successive air curtains positioned progressively closer to the aircraft's engine.

4. The system of claim 3, wherein a first air curtain is configured to rotate a bird into a high-drag orientation and subsequent air curtains apply lateral aerodynamic forces to displace the bird from the engine-intake path.

5. The system of claim 1, wherein the source of pressurized gas comprises one or more compressed-gas bottles containing dry nitrogen, a plenum chamber, and fast-acting pneumatic valves.

6. The system of claim 5, wherein each gas bottle is pressurized to approximately 207 bar and is configured to discharge for approximately one second.

7. The system of claim 1, wherein the source of airflow comprises one or more electric blowers driven by electric motors powered by supercapacitors.

8. The system of claim 7, wherein the supercapacitors deliver sufficient energy to accelerate the motors from idle to full speed within the response time between detection and activation.

9. The system of claim 1, wherein the detection zone is defined by radar, lidar, optical, or infrared sensors directed along the aircraft flight path.

10. The system of claim 1, wherein the controller selectively activates subsets of nozzles corresponding to predicted bird trajectories or initiates a full-discharge mode in which all nozzles release pressurized gas simultaneously to form a transient high-velocity air envelope across the Bird Cone.

11. The system of claim 1, further comprising a safety interlock configured to prevent activation below a predetermined altitude or airspeed.

12. The system of claim 1, wherein discharge of the air curtain produces a transient yaw not exceeding predefined aerodynamic limits and a temporary airspeed reduction within acceptable safety margins.

13. The system of claim 1, wherein the nozzles are integrated into aerodynamic housings mounted on opposite sides of the fuselage forward of the cockpit.

14. The system of claim 1, further comprising a ground-testing apparatus including a stationary frame replicating an aircraft nose and nozzle arrangement for validating aerodynamic performance in a wind tunnel.

15. A method of deflecting birds from an aircraft engine intake, comprising:
(a) detecting one or more birds within a detection zone ahead of the aircraft;
(b) activating at least one source of pressurized gas or airflow; and
(c) discharging air through nozzles to form one or more air curtains oriented to deflect the birds laterally away from the engine intake.

16. The method of claim 15, wherein discharging comprises sequentially activating air curtains oriented at different angles relative to the aircraft longitudinal axis.

17. The method of claim 15, wherein a first air curtain induces rotation of a bird body and subsequent air curtains increase lateral displacement.

18. The method of claim 15, wherein the discharging step is automatically terminated upon depletion of stored energy.

19. The method of claim 15, further comprising operating the system in a full-discharge mode in which all nozzles release pressurized gas simultaneously to generate a transient high-velocity air envelope providing fail-safe protection against multiple birds or flock encounters.
